(19) United States
(12) Patent Application Publication
(10) Pub. No.: US 2002/0046439 A1
(43) Pub. Date: Apr. 25, 2002

(54) Vehicle door handle

(76) Inventors: Astorre Agostini, Alpignano (IT); Ambrogio Martino, Lanzo Torinese (IT)

Correspondence Address: LERNER, DAVID, LITTENBERG,, KRUMHOLZ & MENTLIK, LLP, 600 SOUTH AVENUE WEST, WESTFIELD, NJ, 07090-1497, US

(21) Appl. No.: 09/791,258

(22) Filed: Feb. 22, 2001

(30) Foreign Application Priority Data
Feb. 23, 2000 (IT) TO2000A 000174

(51) Int. Cl. E05B 1/00

(52) U.S. Cl. 16/110.1

(57) ABSTRACT

A handle for a vehicle door has a frame fittable to the door; a manual control lever connected to the frame and having a control portion connectable mechanically to a lock on the door to release the lock; and an electric control assembly for electrically controlling the lock to activate a security function of the lock; the control assembly having a switch, a push-button activating device for activating the switch and carried by the control portion, and a fluidtight sealing device associated with the control portion to prevent the passage of external contaminants towards the frame.

The present invention relates to a vehicle door handle.

### BACKGROUND OF THE INVENTION

Vehicle doors in general, and motor vehicle doors in particular, are opened by means of a handle, wherein an elongated frame is fitted inside the door and supports a control lever, which has a control end portion connected, in use, to the relative lock, and an opposite end portion connected to the frame by a hinge having a normally vertical axis of rotation, so as to rotate about the hinge axis between a rest position and an extracted position releasing the lock.

More and more modern vehicles are equipped with electronic devices for remote controlling each door lock and, in particular, activating or deactivating the security function of the lock without using the key. For example, a transmitter or so-called ‘badge’ is used, which is carried by the user of the vehicle and provides for transmitting signals to a central control unit on the vehicle, which, on receiving and recognizing the signals, deactivates the security function of the lock.

The same transmitter can also be used to activate the security function of the lock. That is, when the transmitter is a given distance from the vehicle, the central control unit is no longer able to receive the signals emitted by the transmitter, and can be programmed to automatically activate the security function of the lock in the absence of a signal.

Though reliable, the above electronic device has the drawback that, in most cases, the user of the vehicle wishes to activate the security function of the lock immediately, without waiting for it to be done automatically when the transmitter is a given distance from the vehicle.

To enable the security function of the lock to be activated and checked immediately, a handle is used comprising a switch located inside the frame, just beneath the end portion of the lever hinged to the frame, so that the switching member of the switch is movable directly by the end portion of the lever. For this purpose, the hinge interposed between the frame and the end portion of the lever is so formed as to permit not only rotation but also radial displacement of the end portion inwards of the door, so as to trip the switch and so activate the security function of the lock.

The above handle has several drawbacks. In particular, the switch is easily damaged and subject to malfunctioning, on account of said displacement inwards of the door necessarily requiring, between the frame and the end of the lever in the rest position, a certain amount of clearance by which the switch communicates directly with the outside environment, especially in the event the complex seal provided is not positioned correctly or is damaged, e.g. by normal operation of the lever. Moreover, in the event of a fault, replacing the switch is an expensive, relatively time-consuming job involving removal of the entire handle.

Finally, the handle itself is complex in design and therefore expensive to produce, on account of the particular hinge and seal used, as well as the presence of elastic elements, which are indispensable for keeping the handle portion away from the switch, and which are also stressed when normally releasing the lock.

### SUMMARY OF THE INVENTION

It is an object of the present invention to provide a handle featuring a device for activating the security function of the relative lock, but which provides for eliminating the aforementioned drawbacks and is easy to assemble and disassemble.

According to the present invention, there is provided a handle for a vehicle door, the handle comprising a frame fittable to said door; a manual control lever connected to said frame and comprising a control portion connectable mechanically to a lock on said door to release said lock; and electric control means for electrically controlling said lock to activate a security function of the lock; the electric control means comprising a switch, and push-button activating means for activating said switch; characterized in that said push-button activating means are carried by said control portion; and in that fluidtight sealing means are associated with said control portion to prevent the passage of external contaminants/fluids towards said frame.

### BRIEF DESCRIPTION OF THE DRAWINGS

A non-limiting embodiment of the invention will be described by way of example with reference to the accompanying drawings, in which:

FIG. 1 shows a section, with parts removed for clarity, of a preferred embodiment of the handle according to the present invention;

FIG. 2 shows the same view as in FIG. 1, with certain parts of FIG. 1 in a different operating position;

FIG. 3 shows a view in perspective, with parts removed for clarity, of a detail in FIGS. 1 and 2.

### DETAILED DESCRIPTION OF THE INVENTION

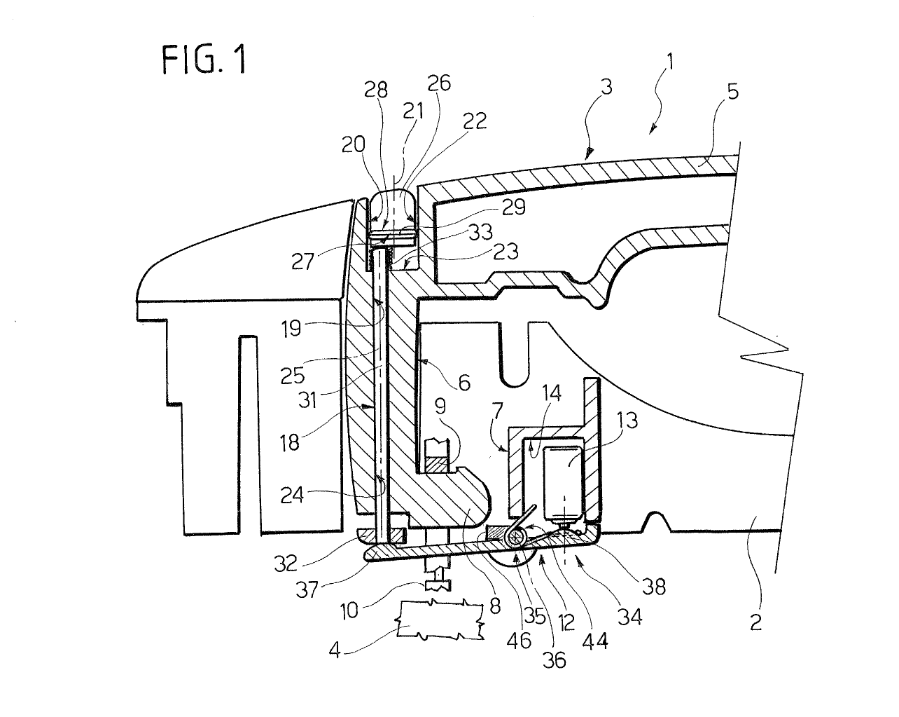

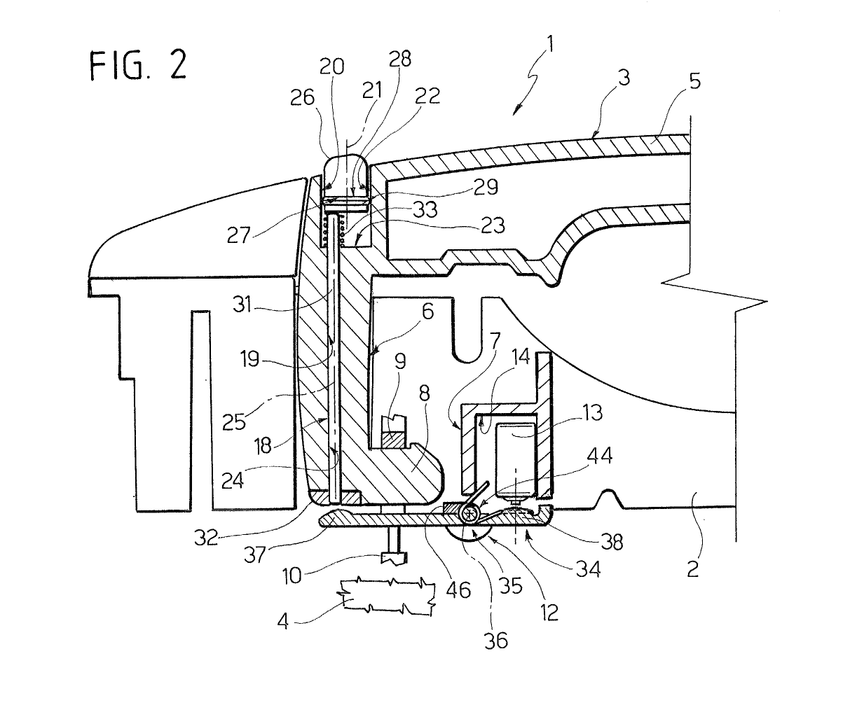

Number 1 in FIGS. 1 and 2 indicates as a whole a handle connectable to a door (not shown) of a vehicle (not shown).

Handle 1 comprises a frame 2 fittable inside the door (not shown) of the vehicle; and a lever 3, which is gripped by the user of the vehicle and is movable manually between a rest position (shown in FIGS. 1 and 2) in which, in use, lever 3 forces a known seal (not shown) against the body of the door, and a work position (not shown) activating a relative lock 4 on the door (not shown).

More specifically, lever 3 is substantially L-shaped and comprises an elongated portion or grip 5 having an end portion (not shown) hinged to frame 2 so as to rotate, with respect to frame 2, about a hinge axis (not shown); and an elongated control portion 6. Control portion 6 extends towards frame 2 in a direction substantially perpendicular to portion 5, loosely engages a through opening 7 formed in frame 2, and terminates with a projecting pin 8, on which rests a known lever 9 connected to a Bowden cable 10 for activating lock 4 when lever 3 is rotated into the work position.

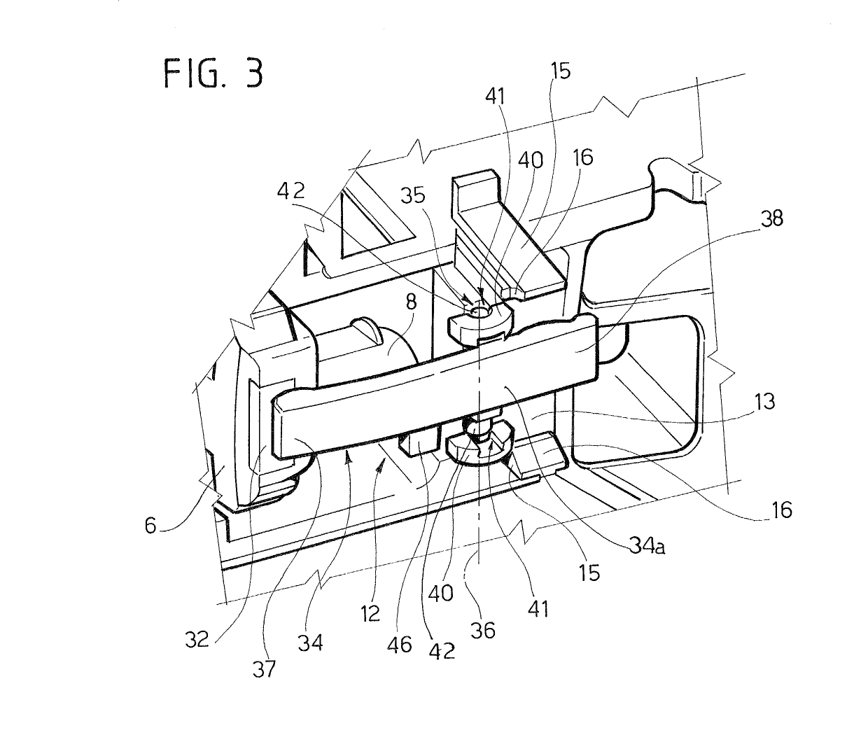

With reference to FIGS. 1 and 2, handle 1 also comprises an electric control assembly 12 for activating the security function of lock 4. Assembly 12 comprises a known push-button switch 13, which is housed inside a cavity 14 in frame 2 and is connected releasably to frame 2 by two elastic appendixes 15 terminating with respective retaining teeth 16 which click on to switch 13 (FIG. 3). Switch 13 is connected electrically in known manner to a central control unit (not shown) for controlling activation of the security function of lock 4, and is controlled by a push-button activating device 18 user-operated manually from the outside and forming part of assembly 12.

Device 18 extends inside portion 6, and in particular inside a conduit 19 extending longitudinally from one end to the other of portion 6 and comprising a larger-section inlet portion 20 having a straight axis 21 and defined by a lateral surface 22 and by a bottom surface 23, and a straight, smaller-section portion 24 which comes out inside portion 20 through surface 23 and has an axis 25 parallel to and offset transversely with respect to axis 21.

Portion 20 houses, in axially-sliding manner along axis 21, a control push-button 26, which forms part of device 18 and comprises a circumferential groove in which is locked an annular connecting portion of an annular seal 28, which also comprises an annular lip 29 projecting radially outwards of the push-button and forced against lateral surface 22 to fluidtight seal conduit 19 and prevent water or external contaminants from infiltrating to frame 2. Portion 24, on the other hand, is engaged in sliding manner and with substantially no clearance by a push rod 31, which projects inside portion 20 and is connected integrally to push-button 26 in known manner—in the example shown, by means of a threaded connection—to move axially along axis 25 together with push-button 26. At the opposite end to that connected to push-button 26, push rod 31 has an end portion projecting from the free axial end of portion 6 and connected integrally to a push head 32. Head 32 and push-button 26 are maintained respectively resting against the free end of portion 6 and in a rest position, in which push-button 26 projects outwards of lever 3, by a wire compression spring 33, which surrounds the portion of push rod 31 extending inside portion 20, is forced between push-button 26 and bottom surface 23, and is sealed in fluidtight manner from the outside by seal 28.

With reference to FIGS. 1 and 2, between device 18 and switch 13 is located a lever transmission, which, in the example shown, comprises a single rocker arm lever 34. Lever 34 forms part of assembly 12, extends substantially perpendicular to push rod 31, and comprises an intermediate portion 34a hinged to frame 2 by a hinge 35 to swing about a hinge axis 36 perpendicular to push rod 31. Lever 34 also comprises two opposite end portions 37 and 38, portion 37 extending facing head 32, and portion 38 extending facing the movable member of switch 13. In the example shown, hinge 35 comprises a fork, the arms 40 of which, integral with frame 2, define respective cylindrical seats 41 coaxial with axis 36 and engaged in rotary manner by respective opposite hinge pins 42 integral with intermediate portion 34a and which click inside seats 41. One of pins 42 is wound with an intermediate portion of a known wire torsion spring 44 having two opposite end portions resting one on frame 2 and the other on an inner surface of intermediate portion 34a to keep lever 34 in a rest position wherein portions 37 and 38 are detached from head 32 and switch 13 respectively, and intermediate portion 34a is maintained resting against a reference portion 46 of frame 2 (FIG. 1).

In actual use, when lever 3 is in the rest position (FIGS. 1 and 2), the security function of lock 4 can be activated easily and immediately by the user pressing push-button 26. That is, when push-button 26 is pressed in opposition to the force exerted by spring 33, push rod 31 is moved towards lever 34 so that head 32 contacts portion 37 of lever 34 to rotate lever 34 and so trip switch 13 to activate the security function of lock 4.

Providing a push-button switching device on, and in particular inside, control portion 6 of lever 3 obviously eliminates the transverse clearance between the hinge portion of lever 3 and frame 2 and, once assembled, between the hinge portion and the door body, thus drastically reducing the likelihood of external agents reaching frame 2 and therefore the electric components inside the door. Frame 2 is also fully safeguarded against external agents on the control portion 6 side, by lever 3, regardless of whether or not security device 18 is activated, remaining permanently in a stable rest position in which a conventional seal connects lever 3 to the body or frame 2 in fluidtight manner.

The passage of external agents through device 18 is also prevented by the particular way in which device 18 is connected to control portion 6 and, in the example shown, by the presence of both seal 28 and the particularly small clearance between the inner surfaces of conduit 19 and the associated movable members. The small clearance and the particular geometry of the conduit in themselves form a barrier preventing the passage of external contaminants towards frame 2 and inside the door.

For the above reasons, switch 13 of handle 1 described is therefore extremely wall protected against external agents; which protection is further enhanced by rocker arm lever 34, which provides for locating switch 13 a considerable distance from control portion 6, and for housing switch 13 inside a respective cavity in frame 2.

Clearly, changes may be made to handle 1 as described herein without, however, departing from the scope of the present invention. In particular, push-button 26 may be connected to lever 3 and to the switch otherwise than as described by way of example, so that device 18 may even extend partly outside control portion 6, thus enabling rocker arm lever 34 to be dispensed with. Rocker arm lever 34 may also be eliminated by locating switch 13 close to head 32, which may be designed to act directly on switch 13. As regards push-button 26, seal 28 may be replaced, for example, with a flexible membrane for sealing the housing of push-button 26 in fluidtight manner, while at the same time permitting axial displacement of push-button 26 inside control portion 6 of lever 3.

1.) A handle (1) for a vehicle door, the handle (1) comprising a frame (2) fittable to said door; a manual control lever (3) connected to said frame (2) and comprising a control portion (6) connectable mechanically to a lock (4) on said door to release said lock (4); and electric control means (12) for electrically controlling said lock (4) to activate a security function of the lock (4); the electric control means (12) comprising a switch (13), and push-button activating means (18) for activating said switch (13); characterized in that said push-button activating means (18) are carried by said control portion (6); and in that fluidtight sealing means (28) are associated with said control portion (6) to prevent the passage of external contaminants/fluids towards said frame (2).

2.) A handle as claimed in claim 1, characterized in that said push-button activating means (18) extend at least partly through said control portion (6).

3.) A handle as claimed in claim 1, characterized in that said control portion (6) comprises a through conduit (19) for entirely housing said push-button activating means (18).

4.) A handle as claimed in claim 3, characterized in that said push-button activating means (18) comprise a control push-button (26) housed at least partly in an inlet (20) of said conduit (19), so as to move, with respect to said control portion (6), to and from an activating position activating said switch (13); and transmission means (31, 32) interposed between said control push-button (26) and said switch (13) and housed inside said conduit (19).

5.) A handle as claimed in claim 4, characterized in that said transmission means (31, 32) comprise a push rod (31) extending inside said conduit (19) and connected to said control push-button (26).

6.) A handle as claimed in claim 5, characterized in that said control push-button (26) and said push rod (31) are aligned with and connected directly to each other.

7.) A handle as claimed in claim 4, characterized in that said fluidtight sealing means (28) are positioned closing said conduit (19).

8.) A handle as claimed in claim 7, characterized in that said fluidtight sealing means (28) cooperate with said control push-button (26) or said transmission means (31).

9.) A handle as claimed in claim 8, characterized in that said fluidtight sealing means comprise an annular seal (28) surrounding said control push-button (26) and mating in sliding manner with an inner surface (22) of said conduit (19).

10.) A handle as claimed in claim 4, characterized in that said push-button activating means (18) also comprise elastic return means (33) for moving said control push-button (26) and said transmission means (31) into a withdrawn rest position.

11.) A handle as claimed in claim 10, characterized in that said conduit (19) comprises an inner axial stop surface (23), and said elastic return means comprise a spring (33) forced between said control push-button (26) and said axial stop surface (23); fluidtight sealing means (28) being located on the opposite side of said spring to said axial stop surface (23) to isolate the spring (33) from the outside.

12.) A handle as claimed in claim 1, characterized in that said switch (13) is connected to said frame (2) and located a distance from said control portion (6); and in that said electric control means (12) also comprise a lever transmission (34) interposed between said push-button activating means (18) and said switch (13).

13.) A handle as claimed in claim 12, characterized in that said lever transmission comprises a single rocker arm lever (34) comprising two lateral portions (37) (38) cooperating in direct contact with said push-button activating means (18) and said switch (13) respectively; hinge means (35) being provided to hinge an intermediate portion (34a) of said rocker arm lever (34) to said frame (2).

14.) A handle as claimed in claim 13, characterized in that said hinge means (35) are click-on hinge means.

15.) A handle as claimed in claim 13, characterized in that said lever transmission also comprises further elastic return means (44) for moving said rocker arm lever (34) into a rest position wherein the rocker arm lever (34) is detached from said switch (13) and rests against a fixed stop (46) of said frame (2).
